(19) United States
(12) Patent Application Publication
(10) Pub. No.: US 2019/0167520 A1
(43) Pub. Date: Jun. 6, 2019

(54) AIR PRESSURE MASSAGER

(71) Applicant: Chang Jae LEE, Busan (KR)

(72) Inventor: Chang Jae LEE, Busan (KR)

(21) Appl. No.: 16/312,811

(22) PCT Filed: Feb. 6, 2017
(86) PCT No.: PCT/KR2017/001258

§ 371 Date: Dec. 21, 2018

(30) Foreign Application Priority Data
Jun. 21, 2016 (KR) 10-2016-0077629

(51) Int. Cl. A61H 39/04; A61H 9/00

(52) U.S. Cl. CPC A61H 39/04; A61H 9/0078; A61H 2205/081; A61H 2205/06; A61H 2205/10; A61H 2201/1246

(57) ABSTRACT

An air pressure massager includes a cylinder; a piston vertically reciprocating inside the cylinder and a main hose connected to the cylinder as a passage supplying and recovering air by vertical reciprocation of the piston. A valve is connected to the main hose to control the supply of air pressure. An air bag connected to the valve performs acupressure using the transferred air pressure. A driving part provides rotational power. A rotary shaft is coupled to the driving part and to a first eccentric cam. A first press bar has an upper end portion that contacts the lower end portion of the first eccentric cam and a lower end portion coupled to the upper end portion of the piston. A second eccentric cam is coupled to the rotary shaft. A second press bar has a lower end portion that contacts the upper end portion of the second eccentric cam.

### TECHNICAL FIELD

The present invention relates to a massager that continuously pressurizes body parts to which massages need to be applied by means of the expansion force and compression force of an air bag, which are produced when air in a cylinder is supplied into the air bag and recovered from the same while a piston moves upward and downward.

### DESCRIPTION OF THE RELATED ART

Korean Patent No. 10-0835755 titled “a high technical skill kyungrak (acupuncture meridians) massage machinery” relates to machinery that forcibly transfers air in a cylinder into an air bag through a hose when an eccentric cam rotates and moves a piston downward, so as to use expansion force produced in the air bag.

The above-described massage machinery is configured to move a piston upward by means of the elasticity of a return spring after pressurizing a body part using the expansion force. However, the air having been supplied into the air bag is almost recovered into the cylinder, and very little air is left in the air bag. When air to be sucked into the cylinder is not enough at the time of moving the piston upward, air pressure inside the cylinder is low. Thus, the piston moves upward slowly due to pressing force of the atmospheric pressure applied on the piston, and noise is made when the piston moves upward.

When the piston moves up to the top dead center, all the air having been supplied into the air bag is recovered into the cylinder. At this moment, a valve has to be replaced such that 100% of the supplied air may be recovered and then supplied into the air bag, and constant expansion force has to be produced in a plurality of air bags so as to perform massages effectively. However, the piston may not move up to the top dead center rapidly only by using the force of the return spring. When the valve is replaced and new air is supplied in the state where all the air is not recovered, air as much as the air remaining in the air bag is short in the air bag. Thus, expansion force is weak.

Therefore, when a return spring is used to move a piston upward, a limited amount of air may not be used completely, and noise is made when a piston starts to move upward.

### DETAILED DESCRIPTION OF THE INVENTION

### Technical Problems

The present invention is directed to providing an air pressure massager which can be operated forcibly so as to move a piston upward, move the piston up to the top dead center rapidly without making noise, and supply a predetermined amount of air alternately to a plurality of air bags without losing the air, in the process of supplying a predetermined amount of air in a cylinder into an air bag and recovering the air from the air bag.

### Technical Solutions

As a means to achieve the above-described purposes, an air pressure massager according to the present invention, which includes a cylinder, a piston vertically reciprocating inside the cylinder, a main hose connected to the cylinder so as to be a passage for supplying and recovering air by the vertical reciprocation of the piston, a valve connected to the main hose so as to supply and cut off air pressure, an air bag connected to the valve so as to perform an acupressure function by using the transferred air pressure, and a driving part for providing rotational power, may include a rotary shaft coupled to the driving part, a first eccentric cam coupled to the rotary shaft, a first press bar the upper end portion of which comes into contact with the lower end portion of the first eccentric cam and the lower end portion of which is coupled to the upper end portion of the piston, a second eccentric cam coupled to the rotary shaft, a second press bar the lower end portion of which comes into contact with the upper end portion of the second eccentric cam, a link for connecting the first press bar and the second press bar, a circular container coupled to the rotary shaft and having a bar on both surfaces thereof for controlling a noise prevention valve, a circular disc cam opening and closing a valve piston while alternately rotating left and right by the rotation of the circular container, a valve piston the upper end portion of which comes into contact with the lower end portion of the circular disc cam, and a hose for connecting a hole configured as an air passage of the valve piston and the cylinder such that air passes, wherein when the first press bar moves downward by the eccentric rotation of the first eccentric cam, the second press bar connected to the first press bar by the link also moves downward, and when the second press bar moves upward by the eccentric rotation of the second eccentric cam, the first press bar connected to the second press bar by the link also moves upward.

As a means to achieve the above-described purposes, an air pressure massager according to the present invention, which includes a cylinder, a piston vertically reciprocating inside the cylinder, a main hose connected to the cylinder so as to be a passage for supplying and recovering air by the vertical reciprocation of the piston, a valve connected to the main hose so as to supply and cut off air pressure, an air bag connected to the valve so as to perform an acupressure function by using the transferred air pressure, and a driving part for providing rotational power, may include a rotary shaft coupled to the driving part, a grooved cam coupled to the rotary shaft and having a groove corresponding to a curved outline of the cam on the flat surface of one side thereof, and a press bar for a grooved cam whose lower end portion is coupled to the upper end portion of the piston and which vertically reciprocates by means of changes in the height of the groove of the grooved cam according to the rotation of the grooved cam by inserting a bearing protruding from the upper end portion of the press bar for a grooved cam in the lateral direction thereof into the groove of the grooved cam.

Additionally, as a means to achieve the above-described purposes, an air pressure massager according to the present invention, which includes a cylinder, a piston vertically reciprocating inside the cylinder, a main hose connected to the cylinder so as to be a passage for supplying and recovering air by the vertical reciprocation of the piston, a valve connected to the main hose so as to supply and cut off air pressure, an air bag connected to the valve so as to perform an acupressure function by using the transferred air pressure, and a driving part for providing rotational power, may include a rotary shaft coupled to the driving part, a pinion coupled to the rotary shaft, a cylindrical grooved cam configured as a cylinder-shaped member having flat upper and lower surfaces, having saw teeth which are formed along the edge of the upper surface thereof and engaged with the pinion, and having a groove which is formed and gives a turn along a curved surface on the lateral surface of the cylindrical grooved cam and whose height is continuously changed, and a press bar for a cylindrical grooved cam whose lower end portion is coupled to the upper end portion of the piston and which vertically reciprocates by means of changes in the height of the groove of the cylindrical grooved cam according to the rotation of the cylindrical grooved cam by inserting a bearing protruding from the upper end portion of the press bar for a grooved cam in the lateral direction thereof into the groove of the cylindrical grooved cam.

Additionally, as a means to achieve the above-described purposes, an air pressure massager according to the present invention, which includes a cylinder, a piston vertically reciprocating inside the cylinder, a main hose connected to the cylinder so as to be a passage for supplying and recovering air by the vertical reciprocation of the piston, a valve connected to the main hose so as to supply and cut off air pressure, an air bag connected to the valve so as to perform an acupressure function by using the transferred air pressure, and a driving part for providing rotational power, may include a rotary shaft coupled to the driving part, an eccentric cam coupled to the rotary shaft, a press bar the upper end portion of which comes into contact with the lower end portion of the eccentric cam and the lower end portion of which is coupled to the upper end portion of the piston, and a return spring built into a spring box in a space at the lower side of the piston inside the cylinder and applying pushing force so as to move the piston upward when the return spring is compressed.

Additionally, the piston is preferably further provided with a through hole vertically penetrating the piston, a pressure valve installed inside the through hole and opened when air pressure inside the cylinder is lower than air pressure in a space at the upper side of the piston so as to settle differences in the air pressure at the upper and lower sides of the piston, and an air suction valve installed on the lateral wall of the upper portion of the cylinder and opened when air pressure inside the cylinder is lower than air pressure outside the cylinder.

### Advantageous Effects

The present invention has the advantage of being operated forcibly only with a cam, moving a piston up to the top dead center rapidly without making noise, enabling the expansion force of an air bag to remain constant, thereby making it possible to continuously perform messages, instead of removing a return spring that is a means to move a piston up in the process of moving the piston upward and downward so as to supply and recover air in the cylinder.

### BRIEF DESCRIPTION OF THE DRAWINGS

FIG. 1 is a front view of an air pressure massager provided with a noise prevention valve which prevents noise while forcibly driving a piston with first and second eccentric cams according to an embodiment of the present invention.

FIG. 2 illustrates the structure of a noise prevention valve.

FIG. 2A is a front view of the structure of a noise prevention valve, FIG. 2B is a right side view thereof, and FIG. 2C is a reference view illustrating changes in the height of the bottom surface of a circular disc cam as lines.

FIG. 3 illustrates a state where a first eccentric cam according to an embodiment of the present invention moves a piston downward while rotating.

FIG. 4 is a side view of a second eccentric cam according to an embodiment of the present invention.

FIG. 5 is a view of an air pressure massager according to an embodiment of the present invention, provided with a valve having plurality of valve holes connected to a hose the end of which is connected with two air bags so as to massage acupuncture meridians.

FIG. 6 is a front view of an air pressure massager which is driven using a grooved cam and a press bar therefor according to another embodiment of the present invention.

FIG. 7 is a side view of a grooved cam according to another embodiment of the present invention.

FIG. 8 is a front view of an air an air pressure massager using a gear and a cylindrical grooved cam according to another embodiment of the present invention.

FIG. 9 is a perspective view of the gear and cylindrical grooved cam of the air pressure massager in FIG. 7.

FIG. 10 is a front view of an air pressure massager using a pressure valve and a return spring according to another embodiment of the present invention.

FIG. 11 is a front view of an air pressure massager using a return spring, a valve cam for opening and closing a valve, and a valve according to yet another embodiment of the present invention.

FIG. 12 is a front view of a valve cam assembled with the air pressure massager in FIG. 11.

### BEST MODE FOR CARRYING OUT THE INVENTION

According to the present invention, an air pressure massager, which includes a cylinder, a piston vertically reciprocating inside the cylinder, a main hose connected to the cylinder and configured as a passage for supplying and recovering air by the vertical reciprocation of the piston; a valve connected to the main hose so as to supply and cut off air pressure; an air bag connected to the valve so as to perform acupressure by using the transferred air pressure; and a driving part for providing rotational power, includes a rotary shaft coupled to the driving part; a first eccentric cam coupled to the rotary shaft; a first press bar the upper end portion of which contacts the lower end portion of the first eccentric cam and the lower end portion of which is coupled to the upper end portion of the piston; a second eccentric cam coupled to the rotary shaft; a second press bar the lower end portion of which contacts the upper end portion of the second eccentric cam; a link for connecting the first press bar and the second press bar; a circular container coupled to the rotary shaft and having a bar on both surfaces thereof for controlling a noise prevention valve; a circular disc cam opening and closing a valve piston while alternately rotating left and right by the rotation of the circular container; a valve piston the upper end portion of which contacts the lower end portion of the circular disc cam; and a hose connecting a hole configured as an air passage of the valve piston and the cylinder such that air passes, wherein the second press bar connected to the first press bar by the link also moves downward when the first press bar moves downward by the eccentric rotation of the first eccentric cam, and the first press bar connected to the second press bar by the link also moves upward when the second press bar moves upward by the eccentric rotation of the second eccentric cam.

### MODE FOR CARRYING OUT THE INVENTION

The present invention is specifically described with reference to the attached drawings as follows.

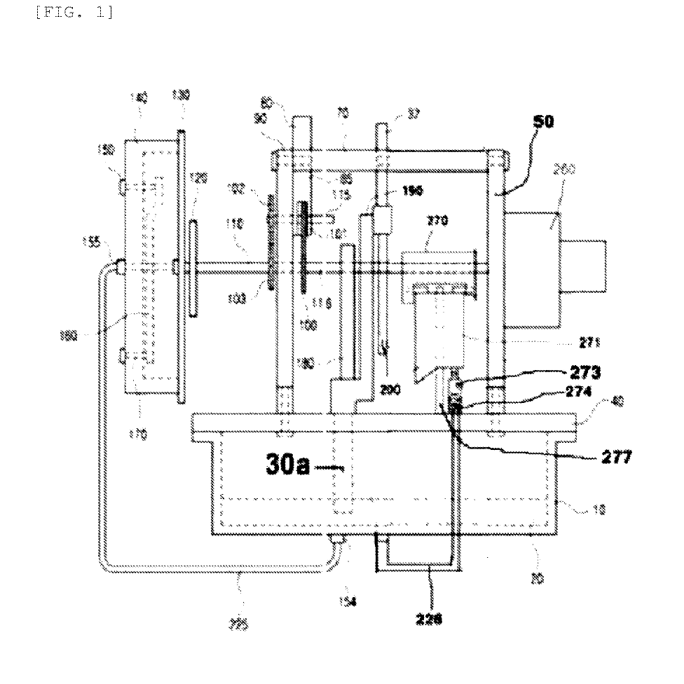

FIG. 1 is a front view of an air pressure massager which forcibly drives a piston upward and downward with first and second eccentric cams according to an embodiment of the present invention and is provided with a noise prevention valve.

A base block 40 coupled to the upper end of a cylinder 10, a main block 50 erected upward on the base block, and an assistant block 90 erected at a predetermined distance away from the main block 50 are assembled. A geared motor and a speed reducer are coupled to the main block 50, and a first eccentric cam 180 and a second eccentric cam 200, a circular container 270 having a bar on both surfaces thereof for controlling a noise prevention valve are fixedly coupled to a rotary shaft 116 which rotates by means of the operation of the geared motor and is rotatably supported by the main block 50 and the assistant block 90. Both end portions of a guide 70 are respectively coupled to the upper end portion of the main block 50 and the upper end portion of the assistant block 90, and the guide is installed so as to horizontally cross the upper end portion of the main block and the upper end portion of the assistant block.

When power is supplied to the motor, the first eccentric cam 180 rotates. In this case, a first press bar 30a, and a second press bar 37 which is connected with a piston 20 coupled to the lower end of the first press bar by a link 190 simultaneously move downward.

When the piston 20 moves downward, air in the cylinder 10 below the piston 20 is forcibly transferred into a valve 140 through a main hose 225 and then transferred into two air bags 210 connected with only one opened valve among twelve valve holes 230 so as to expand the air bags 210.

The second eccentric cam 200 moves the second press bar 37 upward while rotating, as the rotary shaft 116 continues to rotate after body parts are pressurized by means of the expansive force. In this case, the first press bar 30a connected with the second press bar by the link 190, and the piston 20 coupled with the first press bar 30a move upward.

When the piston 20 moves upward, the space where air rarely exists is created in the cylinder 10. Thus, the air having been supplied into the air bag 210 is recovered, and the expansive force of the air bag 210, applied to the body parts, ceases to exist, thereby making pressure cease to exist.

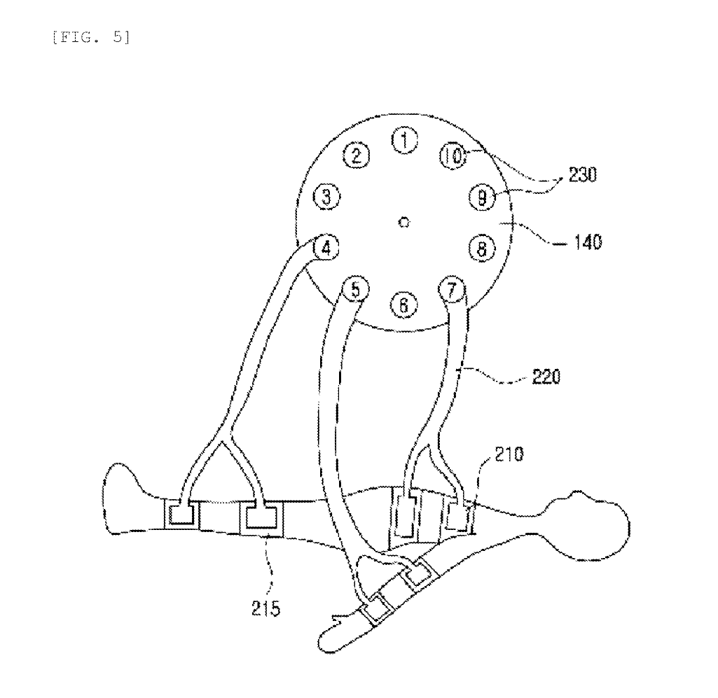

Massages are continuously performed through the above-described process. As a first passive gear 101, coupled with a gear shaft 115 that is engaged with a first single-tooth gear 100 and is rotatably supported by the assistant block 90, rotates as first single-tooth gear 100 coupled with the rotary shaft 116 rotates, a second single-tooth gear 102 coupled with the gear shaft 115 rotates as the first passive gear 101 rotates, and a second passive gear 103, engaged with the second single-tooth gear 102 and coupled to a circular disc cam shaft 110, rotates as the second single-tooth gear 102 rotates so as to operate only one valve. Twelve valve holes 230 are opened consecutively one by one, and air having been supplied into the cylinder 10 is supplied to the air bag 210 connected to the opened valve through the opened valve such that massages are performed on the body part contacting the air bag. Massages are performed as illustrated in FIG. 5.

Details on the valve that operates by means of the rotation of the first single-tooth gear 100, the first passive gear 101, the second single-tooth gear 102, the second passive gear 103 and the circular disc cam 160 are disclosed in South Korean Patent No. 10-0835755 and will be omitted herein.

Meanwhile, the circular having a bar on both surfaces thereof for controlling a noise prevention valve is coupled to the rotary shaft 116, rotates the circular disc cam 271 left to right while rotating, opens a valve piston 273 under the circular disc cam right before the piston 20 moves upward so as to discharge compressed air from the air bag and remove air pressure, and then starts to move the piston upward so as to prevent noise that is made while the piston pops out by means of air pressure supporting the piston. Air is sucked into the cylinder 10 through the opened valve while the piston moves upward. Thus, when the piston 20 rapidly move up to the top dead center and then moves downward in the state where the valve piston 273 is closed right before the piston moves downward, massages may be continuously performed while air in the cylinder is supplied and recovered into the air bag through the valve.

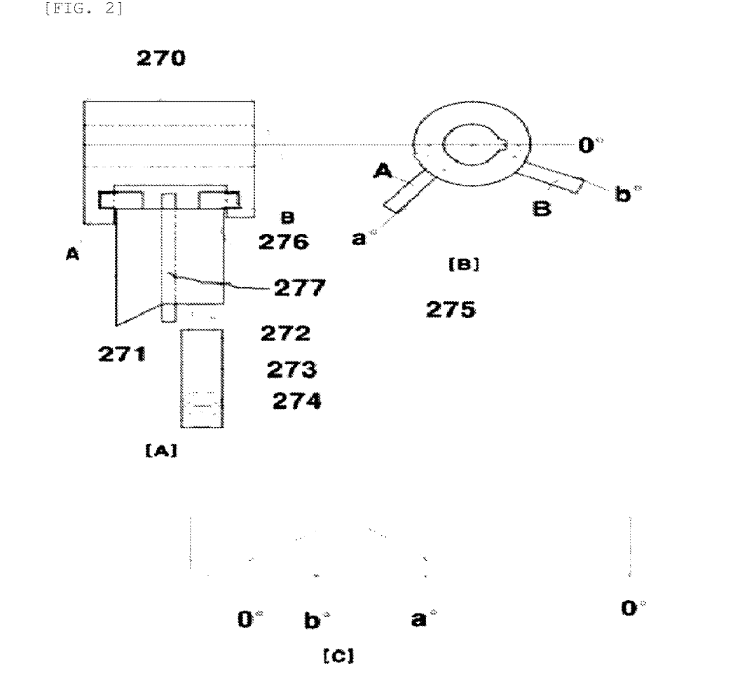

FIG. 2 illustrates the structure of a noise prevention valve. When the circular container 270 having a bar on both surfaces thereof pushes the projection 276 of the circular disc cam while being coupled to the rotary shaft 116 and rotating in the direction of the arrow, the circular disc cam rotatably supported by the circular disc cam shaft 277 alternately rotates left and right so as to open and close the valve piston.

Specifically, when a bar A pulls the projection of the circular disc cam while rotating, the circular disc cam rotates left, and the high portion of the lower surface of the circular disc cam stops over the valve piston 273. In this case, a horizontal hole of the valve piston 273 moves over a valve cylinder 272 so as to discharge air from the air bag and remove air pressure. Then, when the piston 20 moves upward by means of the rotation of the second eccentric cam 200 in the state where air pressure is removed, noise is not made, and when the valve is opened while the piston 20 moves upward, enough air is sucked into the cylinder 10.

When a bar B pulls the projection of the circular disc cam 276 by means of the continuous rotation of the circular container 270 having a bar on both surfaces thereof, the inclined surface and low portion of the lower end of the circular disc cam move over the valve piston 273 while the circular disc cam rotates right, and when the valve piston 273 is pressed downward, a horizontal hole 275 moves downward into the valve cylinder 272. In this case, when the piston 20 moves downward by means of the rotation of the first eccentric cam 180 in the state where air is blocked, 100% of air in the cylinder 10 is supplied into the air bag. Thus, the expansive force of the air bag remains constant such that massages may be performed without noise.

FIG. 2C is a reference view illustrating changes in the height of the lower end of a circular disc cam according to the central angle thereof as straight lines.

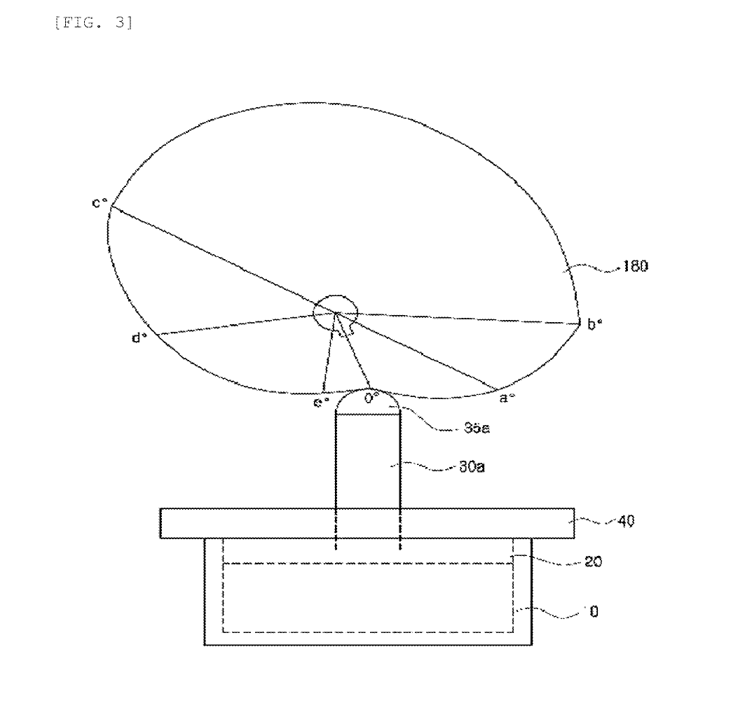

FIG. 3 illustrates a configuration in which a first eccentric cam 180 moves a first press bar 30a downward contacting the lower end of the first eccentric cam 180 while rotating around a rotary shaft 116.

A needle bearing 35a is assembled onto the upper portion of the first press bar 30a, and the piston 20 is screw-coupled to the lower end portion of the first press bar 30a.

While the portion where the central angle of the eccentric cam is 0° rubs against the bearing 35a at the upper portion of the first press bar 30a, the first press bar 30a and the piston 20 are positioned at the top dead center. When the first eccentric cam 180 rotates in the direction of the arrow, passes through the central angle of a° where the radius of the eccentric cam becomes long, and the portion of b° rubs against the bearing 35a, the piston 20 moves downward to the bottom dead center. While the section from b° to c° rubs against the bearing 35a, the radius of the cam remains the longest. Thus, the piston stays at the bottom dead center.

The radius of the first eccentric cam becomes short from the portion of c°. Thus, the first press bar 30a and the piston 20 connected by the link 190 move upward while the second press bar 37 moves upward by means of the second eccentric cam 200. When the portion of e° rubs against the bearing 35a, the first press bar 30a and the piston 20 connected to the lower end of the first press bar move up to the top dead center again.

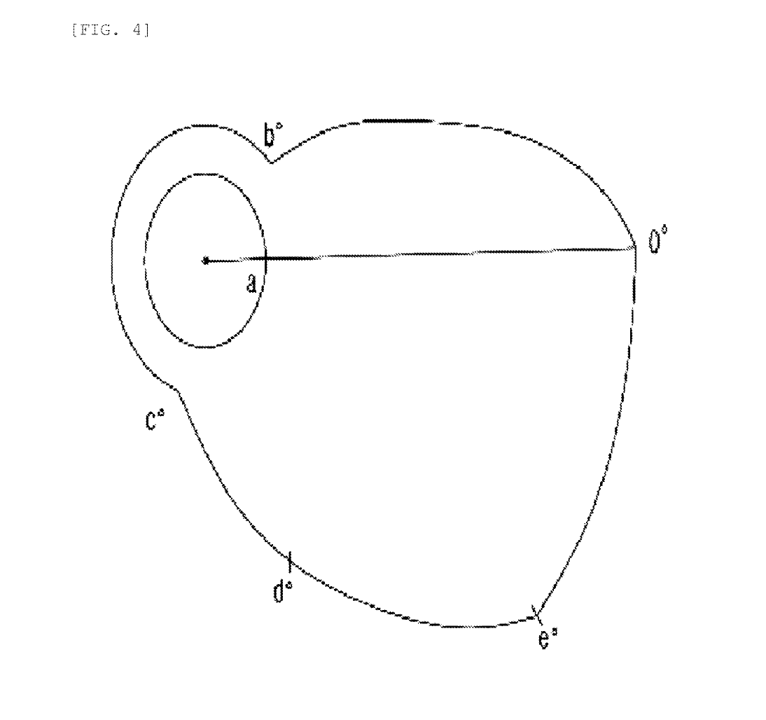

FIG. 4 illustrates a second eccentric cam 200, and the second eccentric cam 200 moves the piston 20 upward and downward in cooperation with the first eccentric cam 180 while moving the second press bar 35 upward.

The second eccentric cam 200 is used to move the piston 20 upward. As opposed to the first eccentric cam 180, the second eccentric cam 200 moves the second press bar 37 upward and simultaneously moves the first press bar 30a connected with the second press bar by the link 190 and the piston 20 coupled to the lower end of the first press bar while the second press bar 37 is positioned over the second eccentric cam 200, and the second eccentric cam 200 rotates below the second press bar 37.

The first press bar 30a and the second press bar 37 are engaged by the link 190 so as to be simultaneously moved upward and downward. The piston 20 moves upward and downward by means of the rotation of the first 180 and second 200 eccentric cams. The second press bar 37 extends upward and penetrates a guide hole formed at the guide 70 such that the guide 70 may guide the upward and downward movements of the second press bar 37.

Specifically, when the first eccentric cam 180 moves the first press bar 30a downward while rotating, the piston 20, coupled to the lower end of the first press bar 30a, and the second press bar 37, connected with the first press bar 30a by the link 190, simultaneously moves downward, and when the rotary shaft 116 continuously rotates, and the second eccentric cam 200 moves the second press bar 37 upward, air in the cylinder is supplied and recovered into the air bag, while the first press bar 30a, connected with the second press bar 37 by the link 190, and the piston 20, coupled to the lower end of the first press bar 30a, also move upward, such that massages may be continuously performed.

FIG. 5 illustrates a state where massages are performed with a belt 215 and an air bag 210. A hose 220 is inserted into each of the plurality of valve holes provided to the valve 140, an air bag 210 is connected to the opposite end of the hose 220, the air bag 210 is attached to a body part to which massages need to be applied, and then, a belt 215 is fastened around the air bag 210 such that massages are performed.

When air is supplied into the air bag 210 through the valve 140, a flat air bag 210 is inflated, the belt 215 is pulled, and the body part fastened by the belt 215 is pressurized. When the piston 20 moves upward again, air having been supplied to the air bag 210 is sucked into the cylinder 10 again, and pressure is dealt with. This process is repeated such that massages are continuously performed.

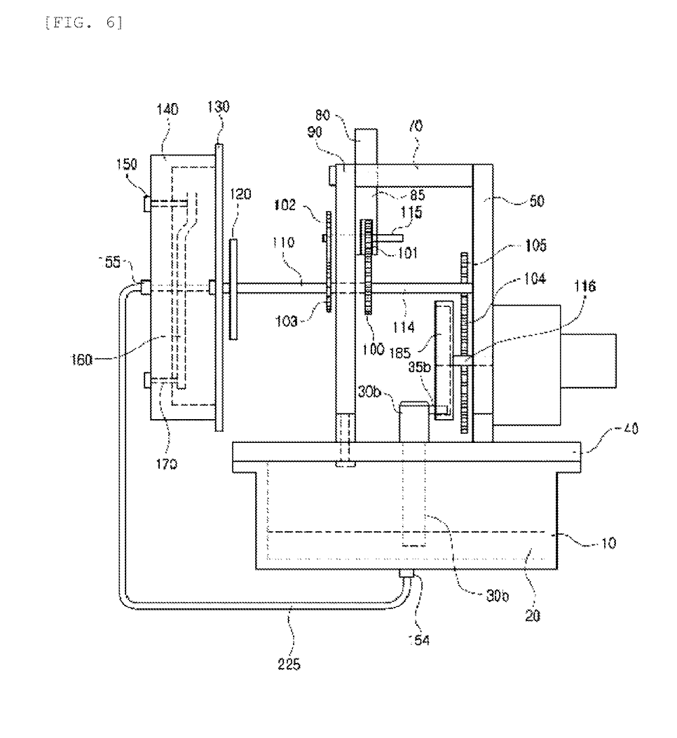

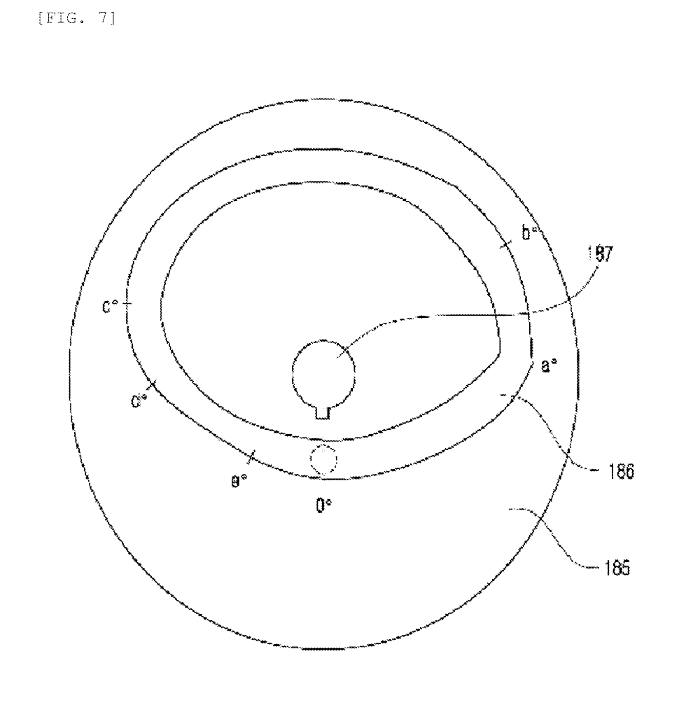

FIGS. 6 and 7 illustrate another embodiment of the present invention.

According to the embodiment illustrated in FIG. 1, a first eccentric cam 180, a first press bar 30a, a second eccentric cam 200 and a second press bar 37 are used to move a piston 20 upward and downward. However, according to this embodiment, a grooved cam 185 and a press bar for a grooved cam 30b are used to move a piston 20 upward and downward. As in the case of the massager in FIG. 1, the massager in FIGS. 6 and 7 uses only cams so as to move a piston 20 upward and downward without s spring.

FIG. 7 is a side view of the grooved cam 185 of the embodiment illustrated in FIG. 6.

When a grooved cam 185 rotates in the direction of the arrow in the state where the bearing 35b of a press bar for a grooved cam 30b is fitted into the groove 186 of the grooved cam 185, the press bar for a grooved cam 30b moves upward and downward according to the height of the groove 186. When the groove 186 corresponding to the portion where the central angle of the grooved cam 185 is 0° rubs against the bearing 35b, the groove 186 is positioned closest to a shaft hole 187. In this case, the press bar for a grooved cam 30b is moved uppermost. Thus, the bearing 35b fitted into the groove 186 moves up to the top dead center, and the piston 20 coupled to the press bar for a grooved cam 30b also moves up to the top dead center.

The press bar for a grooved cam 30b is always positioned in the vertically downward direction of the shaft hole 87. Thus, when rotating, the grooved cam 185 moves upward and downward according to the height of the groove 186.

When the grooved cam 185 rotates in the direction of the arrow, the groove 186 becomes gradually farther from the shaft hole 187 while the groove 185 from the central angle of 0° to the central angle of a° rubs against the bearing 35b. Thus, the press bar for a grooved cam 30b moves downward gradually. Thus, the press bar for a grooved cam 30b moves downward gradually. The press bar for a grooved cam 30b stops at the bottom dead center while the section from b° to c°, where the groove 186 is positioned farthest from the center of the shaft hole 187, rubs against the bearing 35b.

The press bar for a grooved cam 30b starts to move upward from the moment when the portion of c° rubs against the bearing 35b by means of the continuous rotation of the grooved cam 185, and when the portion of e° rubs against the bearing 35b, the press bar for a grooved cam 30b moves up to the top dead center again.

Thus, when the grooved cam 185 continuously rotates, the press bar for a grooved cam 30b and the piston 20 continuously move upward and downward, and air in the cylinder is supplied and recovered such that massages may be continuously performed.

The press bar for a grooved cam 30b has a different shape from the first press bar 30a. Because the bearing 35b rotates in the state where the bearing is fitted into the groove 186 of the grooved cam 185, the press bar for a grooved cam 30b moves upward and downward according to the height of the groove 186 of the grooved cam 185 and moves the piston 20 coupled to the lower end thereof upward and downward.

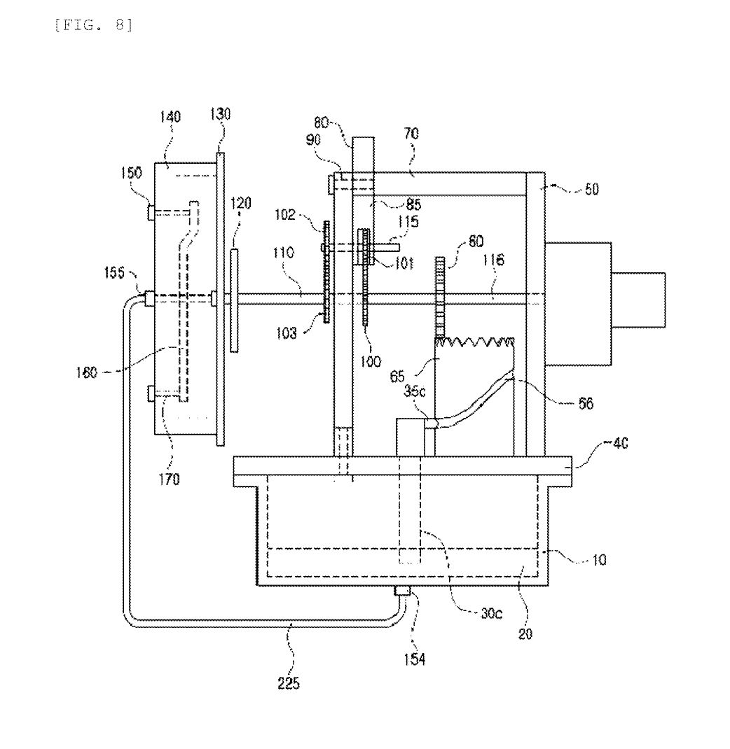

FIG. 8 illustrates an embodiment configured to move a press bar for a cylindrical grooved cam 30c upward and downward while the cylindrical grooved cam 65, a variation of the grooved cam 185 of the embodiment in FIG. 6, rotates.

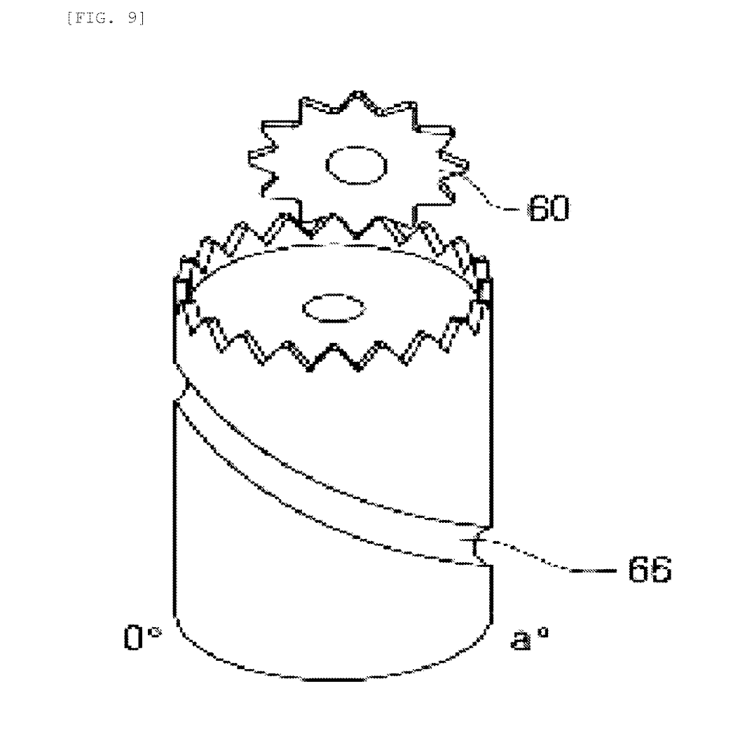

According to this embodiment, as illustrated in FIG. 9, when a pinion 60 such as a spur gear having a usual involute tooth profile rotates around a horizontal rotary shaft 116, the pinion is engaged with the saw teeth circularly arranged along the edge of the upper surface of the cylindrical grooved cam 65 and makes the cylindrical grooved cam 65 rotate. A gear with the above-described configuration is similar to a face gear among intersecting axe gears. When the cylindrical grooved cam 65 rotates, the bearing 35c moves upward and downward according to the height of the groove 66, and the press bar for a cylindrical grooved cam 30c moves the piston 20 upward and downward while moving upward and downward because the bearing 35c is fitted into the groove 66 of the cylindrical grooved cam 65.

In FIG. 9, while the portion where the central angle is 0° rubs against the bearing 35c, the groove 66 is positioned uppermost, and the press bar for a cylindrical grooved cam 30c reaches the top dead center. When the cylindrical grooved cam 65 rotates in the direction of the arrow, and the portion of a° moves close to the bearing 35c, the press bar for a cylindrical grooved cam 30c moves downward, and when the cylindrical grooved cam 65 continuously rotates, the press bar for a cylindrical grooved cam 30c moves upward and downward according the position of the groove 66, and air in the cylinder is supplied and recovered such that massages are performed.

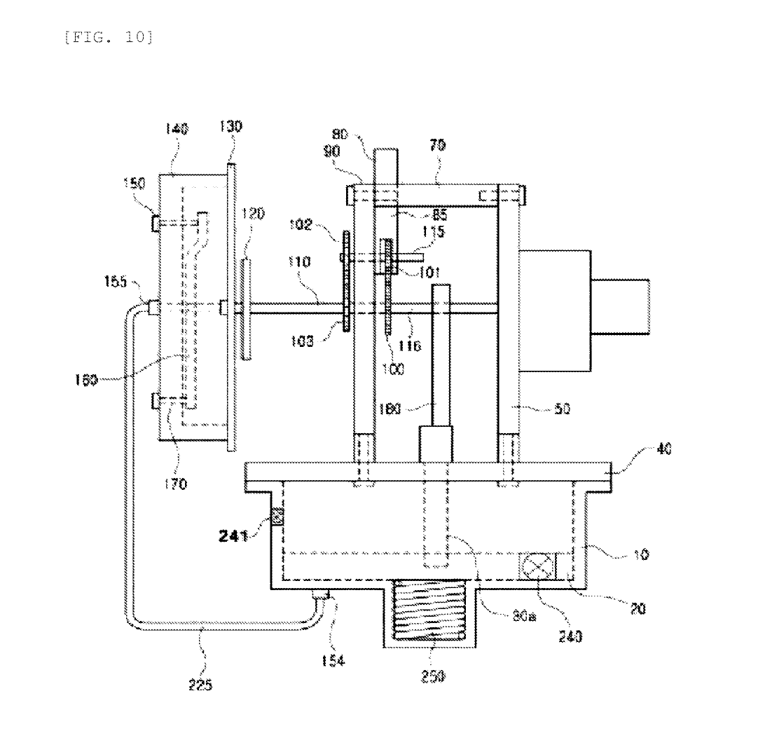

FIG. 10 is a front view of an air pressure massager using an eccentric cam 180 and a return spring 250 according to another embodiment of the present invention.

According to this embodiment, an air pressure massager further includes a return spring 250, which supports the piston 20 and is built into a spring box 11 at the lower end of the cylinder 10, instead of a second eccentric cam, a second press bar and a link according to the embodiment in FIG. 1, wherein the return spring is compressed when the piston 20 moves downward, and when the portion, where the radius of the eccentric cam 180 is short, rubs against the press bar 30, the piston 20 moves upward by means of the elasticity of the return spring, a pressure valve 240 provided to the piston 20, and an air suction valve 241 provided to the side wall of the upper portion of the cylinder 10 are further included.

The pressure valve 240 as a check valve plugs the inside of a through hole formed at the piston so as to penetrating the piston in the up-down direction thereof. A spring is provided inside a usual check valve so as to support the valve elastically. When the valve is pressed by an external force stronger than the elasticity of the spring, the valve moves creating a gap and is opened so as to allow air to move. When the external force is weaker than the elasticity of the spring, the gap disappears because the valve is pushed by the spring, and the valve is closed.

According to the present invention, when air in the cylinder 10 is forcibly transferred to the air bag 210 while the piston 20 moves downward, the space in the air bag 210 is smaller than the space in the cylinder 10, and the air is compressed, thereby producing the air pressure of about 200 g per square centimeter (cm²).

When the piston 20 moves downward, the pressure of air in the air bag 210 is higher than that in the atmosphere. When some of the air leaks through a connecting portion of a hose for six seconds after the piston moves downward, and the piston 20 moves upward again, air as much as the leaked air is not sucked into the cylinder 10. Thus, the air pressure in the cylinder 10 is weaker than the atmospheric pressure.

For instance, if 5% of air is lost, the pressure of 50 g per square centimeter is weaker than the atmospheric pressure. Suppose that the cross section dimension of the piston 20 moving upward is 200 cm². The piston 20 is pressed by the atmospheric pressure corresponding to 200 kg. Thus, air in the cylinder 10 is short of force for supporting the piston 20 corresponding to 10 kg.

When the piston 20 is near the bottom dead center, the return spring 250 is compressed and has high elasticity, and air pressure is applied. In this case, the piston easily moves upward. However, when the piston is near the top dead center, the return spring 250 is almost stretched and has low elasticity, and the pressing force of the atmospheric pressure applied on the piston 20 is stronger than the elasticity of the return spring 250. Thus, the piston does not move up easily.

Supposed that the cross section dimension of the upper surface of the pressure valve 240 is 1 cm². The valve is pressed by the atmospheric pressure corresponding to 1 kg. Thus, the pressure valve 240 is supported by the air pressure in the cylinder 10 corresponding to 950 g that accounts for 95% of the pressing force of the atmospheric pressure. The pressing force of the atmospheric pressure, which is applied to the pressure valve 240, is 50 g stronger than the supporting force of the air pressure. If the force of the return spring 250 for pushing up the pressure valve 240 corresponds to 20 g, the pressing force of the atmospheric pressure is 30 g stronger than the force of the return spring. The pressure valve 240 is pressed by the atmospheric pressure. In this case, the pressure valve 240 is opened, and air at the upper portion of the pressure valve 240 is sucked into the cylinder 10. Thus, air pressure inside the cylinder 10 at the lower portion of the piston 20 becomes identical with that outside the cylinder at the upper portion of the piston 20 thereby making it possible to move the piston 20 upward only with the force of the return spring 250.

When the air suction valve 241 as a check valve is attached to any portion that is linked to the inside of the cylinder 10 except for the piston, the air suction valve 241 is automatically opened by means of the difference in air pressure, and air is sucked into the cylinder 10. As a result, the piston easily moves upward. That is, the atmospheric pressure outside the cylinder 10 is automatically balanced with the air pressure inside the cylinder 10 by means of the air suction valve 241. In the cylinder 10, the air pressure at the upper portion of the piston 20 and the air pressure at the lower portion of the piston 20 are automatically controlled and balanced by means of the pressure valve 240.

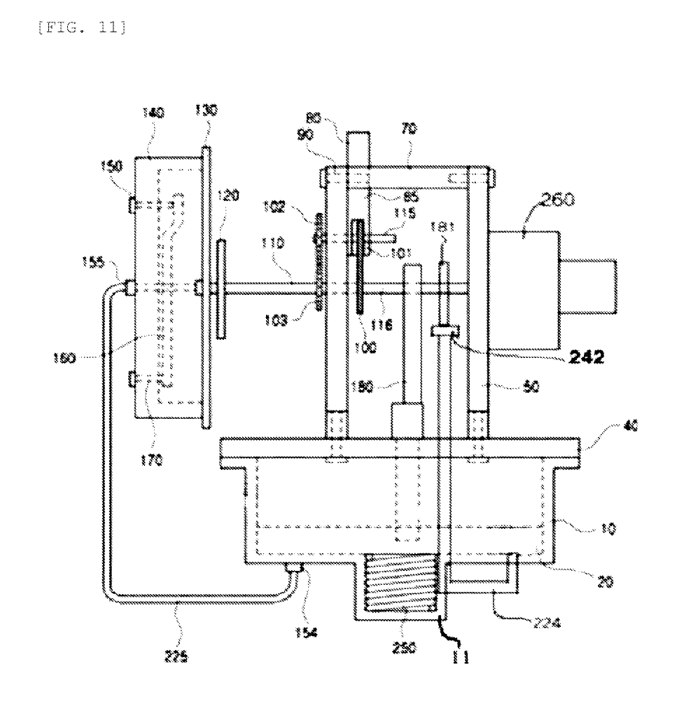

FIG. 11 is a front view of an air pressure massager using a return spring 250, a valve, and a valve cam 181 for opening and closing a valve according to yet another embodiment of the present invention so as to easily move a piston 20 upward. According to this embodiment, a return spring 250, pushing and supporting the piston 20 and built into a spring box 11 at the lower end of the center of the cylinder 10, and a hose 224, connecting an air suction valve 241 and a suction mouth at lower end of a cylinder 10, which are opened and closed by means of the rotation of the valve cam 181 assembled with a rotary shaft 116, are included instead of a second eccentric cam, a second press bar and a link according to the embodiment in FIG. 1. Right before the piston moves upward, the valve cam 181 opens the valve 242 so as to discharge some of the compressed air. Then, air pressure that rapidly moves the piston upward is partially removed, and the piston 20 moves upward only with the elasticity of a spring, when the piston moves upward. Thus, noise caused by the upward movement of the piston 20 significantly decreases. When the valve is opened during the upward movement of the piston 20, air sucked into the valve is sufficiently sucked into the cylinder through the hose 224 connected to the lower end of the cylinder. Thus, the piston may move up to the top dead center rapidly even though a return spring has low elasticity.

The piston then moves downward by means of the rotation of the first eccentric cam 180 in the state where the valve 242 is closed by means of the rotation of the valve cam 181, right before the piston 20 moves downward. In this case, 100% of air in the cylinder is supplied into the air bag such that pressing force applied on a body part, to which massages will be performed, may remain constant.

A return spring illustrated in FIG. 1 in Korean Patent No. 10-0835755 may not be installed, and therefore the piston may not normally move upward because the return spring collides with another part. Thus, the spring box 11 is separately provided at the lower end of the cylinder 10 such that the spring is built into the spring box. In this case, the piston moves down to the bottom dead center and then normally moves upward by means of the elasticity that is caused when the spring is compressed.

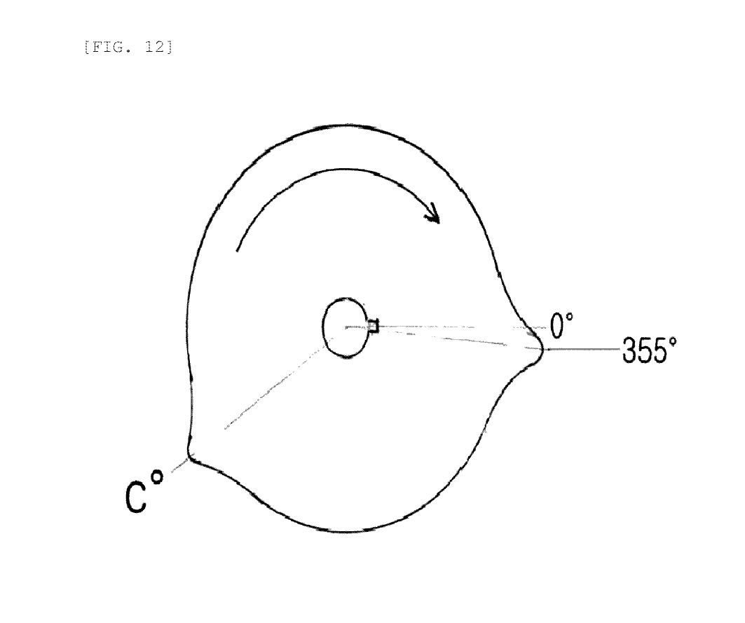

FIG. 12 is a front view of a valve cam for opening and closing a valve. At the moment when a protruding part that is assembled with the rotary shaft 116 and formed at the portion where the central angle of the valve cam is 355° touches the valve 240, while rotating simultaneously together with the first eccentric cam, the valve is closed, and at the moment when the protruding part at the central angle of c° touches the valve 240, the valve is opened. Thus, the protruding part opens the valve right before the piston moves upward while the protruding part closes the valve right before the piston moves downward.

1. An air pressure massager, which comprises a cylinder, a piston vertically reciprocating inside the cylinder, a main hose connected to the cylinder so as to be a passage for supplying and recovering air by the vertical reciprocation of the piston, a valve connected to the main hose so as to supply and cut off air pressure, an air bag connected to the valve so as to perform an acupressure function by using transferred air pressure, and a driving part for providing rotational power, comprising:
a rotary shaft coupled to the driving part;
a first eccentric cam coupled to the rotary shaft;
a first press bar the upper end portion of which comes into contact with the lower end portion of the first eccentric cam and the lower end portion of which is coupled to the upper end portion of the piston;
a second eccentric cam coupled to the rotary shaft;
a second press bar the lower end portion of which comes into contact with the upper end portion of the second eccentric cam; and
a link for connecting the first press bar and the second press bar,
wherein when the first press bar moves downward by the eccentric rotation of the first eccentric cam, the second press bar connected to the first press bar by the link also moves downward, and when the second press bar moves upward by the eccentric rotation of the second eccentric cam, the first press bar connected to the second press bar by the link also moves upward.

2. An air pressure massager, which comprises a cylinder, a piston vertically reciprocating inside the cylinder, a main hose connected to the cylinder so as to be a passage for supplying and recovering air by the vertical reciprocation of the piston, a valve connected to the main hose so as to supply and cut off air pressure, an air bag connected to the valve so as to perform an acupressure function by using transferred air pressure, and a driving part for providing rotational power, comprising:
a rotary shaft coupled to the driving part;
a first eccentric cam coupled to the rotary shaft;
a first press bar the upper end portion of which comes into contact with the lower end portion of the first eccentric cam and the lower end portion of which is coupled to the upper end portion of the piston;
a second eccentric cam coupled to the rotary shaft;
a second press bar the lower end portion of which comes into contact with the upper end portion of the second eccentric cam;
a link for connecting the first press bar and the second press bar, and
Wherein the air pressure massager comprises a circular container coupled to the rotary shaft and having a bar on both surfaces thereof, a circular disc cam alternately rotating left and right by the rotation of the circular container, a valve piston which is opened when the valve piston moves over a hole of the valve cylinder and blocks air when the valve piston is inserted into the hole of the valve cylinder, by the rotation of the circular disc cam, a hose for connecting the hole of the valve piston and the cylinder such that air in the cylinder passes, and a noise prevention valve which is opened right before the valve piston moves upward and closed right before the piston moves downward, and
wherein when the first press bar moves downward by the eccentric rotation of the first eccentric cam, the second press bar connected to the first press bar by the link also moves downward, and when the second press bar moves upward by the eccentric rotation of the second eccentric cam, the first press bar connected to the second press bar by the link also moves upward.

3. An air pressure massager, which comprises a cylinder, a piston vertically reciprocating inside the cylinder, a main hose connected to the cylinder so as to be a passage for supplying and recovering air by the vertical reciprocation of the piston, a valve connected to the main hose so as to supply and cut off air pressure, an air bag connected to the valve so as to perform an acupressure function by using transferred air pressure, and a driving part for providing rotational power, comprising:
a rotary shaft coupled to the driving part;
a grooved cam coupled to the rotary shaft and having a groove corresponding to a curved outline of the cam on the flat surface of one side thereof; and
a press bar for a grooved cam whose lower end portion is coupled to the upper end portion of the piston and which vertically reciprocates by means of changes in the height of the groove of the grooved cam according to the rotation of the grooved cam by inserting a bearing protruding from the upper end portion of the press bar for a grooved cam in the lateral direction thereof into the groove of the grooved cam.

4. An air pressure massager, which comprises a cylinder, a piston vertically reciprocating inside the cylinder, a main hose connected to the cylinder so as to be a passage for supplying and recovering air by the vertical reciprocation of the piston, a valve connected to the main hose so as to supply and cut off air pressure, an air bag connected to the valve so as to perform an acupressure function by using transferred air pressure, and a driving part for providing rotational power, comprising:
a rotary shaft coupled to the driving par;
a pinion coupled to the rotary shaft;
a cylindrical grooved cam configured as a cylinder-shaped member having flat upper and lower surfaces, having saw teeth which are formed along the edge of the upper surface thereof and engaged with the pinion, and having a groove which is formed and gives a turn along a curved surface on the lateral surface of the cylindrical grooved cam and whose height is continuously changed; and
a press bar for a cylindrical grooved cam whose lower end portion is coupled to the upper end portion of the piston and which vertically reciprocates by means of changes in the height of the groove of the cylindrical grooved cam according to the rotation of the cylindrical grooved cam by inserting a bearing protruding from the upper end portion of the press bar for a cylindrical grooved cam in the lateral direction thereof into the groove of the cylindrical grooved cam.

5. An air pressure massager, which comprises a cylinder, a piston vertically reciprocating inside the cylinder, a main hose connected to the cylinder so as to be a passage for supplying and recovering air by the vertical reciprocation of the piston, a valve connected to the main hose so as to supply and cut off air pressure, an air bag connected to the valve so as to perform an acupressure function by using the transferred air pressure, and a driving part for providing rotational power, comprising:
a rotary shaft coupled to the driving part;
an eccentric cam coupled to the rotary shaft;
a press bar the upper end portion of which comes into contact with the lower end portion of the eccentric cam and the lower end portion of which is coupled to the upper end portion of the piston;
a spring box provided at the lower end of the center of the cylinder; and
a return spring built into the spring box and applying pushing force so as to move the piston upward when compressed.

6. The air pressure massager according to claim 5,
wherein the piston is further provided with a through hole vertically penetrating the piston;
a pressure valve installed inside the through hole and opened when air pressure inside the cylinder is lower than air pressure outside the cylinder, so as to settle differences in air pressure inside and outside the cylinder; and
an air suction valve installed on the lateral wall of the upper portion of the cylinder and opened when air pressure inside the cylinder is lower than air pressure outside the cylinder.

7. An air pressure massager, which comprises a cylinder, a piston vertically reciprocating inside the cylinder, a main hose connected to the cylinder so as to be a passage for supplying and recovering air by the vertical reciprocation of the piston, a valve connected to the main hose so as to supply and cut off air pressure, an air bag connected to the valve so as to perform an acupressure function by using transferred air pressure, and a driving part for providing rotational power, further comprising:
a rotary shaft coupled to the driving part;
an eccentric cam and a valve cam coupled to the rotary shaft;
a press bar the upper end portion of which comes into contact with the lower end portion of the eccentric cam and the lower end portion of which is screw-coupled to the upper end portion of the piston; and
a valve opened when the piston moves upward and closed when the piston moves downward, by the rotation of the valve cam, which is coupled to the rotary shaft, and a return spring, which is installed in a spring box provided at the lower end of the cylinder and applies pushing force so as to move the piston upward when the return spring is compressed.
